(19) United States
(12) Patent Application Publication
(10) Pub. No.: US 2007/0015002 A1
(43) Pub. Date: Jan. 18, 2007

(54) Oxygen-donor and catalytic coatings of metal oxides and metals

(75) Inventors: Chaitanya Narula, Knoxville, TN (US); Mark A. Deininger, Roswell, GA (US); Michael Pozvonkov, Cumming, GA (US); Leonid V. Budaragin, Moscow (RU)

Correspondence Address: JOHN S. PRATT, ESQ;KILPATRICK STOCKTON, LLP, 1100 PEACHTREE STREET, ATLANTA, GA, 30309, US

(73) Assignees: UT-BATTELE, LLC; C-3 INT'L, LLC

(21) Appl. No.: 11/181,314

(22) Filed: Jul. 14, 2005

(51) Int. Cl. C25D 5/26; C03C 29/00; B32B 15/00

(52) U.S. Cl. 428/668; 428/627; 428/632; 428/640; 428/633

(57) ABSTRACT

A method to fabricate thin, penetrating coatings of metal oxides with oxygen storage capability is disclosed. The application of these coating in diesel exhaust particulate oxidation, carbonization prevention in ethylene cracking pipes etc. is also disclosed. In this method, the use of thin, penetrating coatings of catalytic metals decreases the oxidation temperature of carbon in contact with or near the coated surfaces. Finally, the invention describes a method to prepare a better bonding surface for laying down catalysts through traditional calcification slurry methods, by pre-coating the surface with a thin, penetrating coating of metal oxide.

### BACKGROUND OF THE INVENTION

1. Field of the Invention

This invention relates to the use of thin, penetrating coatings of metal oxides to provide oxygen-donation for applications where insufficient oxygen exists to support partial or complete combustion of hydrocarbons. The invention also relates to the use of thin, penetrating coatings of catalytic metals to decrease the oxidation temperature of carbon in contact with or near the coated surfaces. Finally, the invention relates to providing a better bonding surface for laying down catalysts through traditional calcification slurry methods, by pre-coating the surface with a thin, penetrating coating of metal oxide.

2. Description of Related Art

Ceramic “papers” have been known in the art, and have been disclosed as useful in filtration media. Ceramic fibers are bound together with a binder into a porous network in three dimensions, and formed into a flat ribbon or sheet. This ribbon or sheet can be pleated or folded, compressed, and contained within a housing, forming a filtration unit. Filtration units called “Traps” containing such materials for use in catching and combusting diesel exhaust particulates are disclosed in U.S. Pat. Nos. 6,328,779 and 6,426,315, the entire contents of each of which are incorporated herein by reference.

Filtration units of this type have been used to filter exhaust from diesel engines, and have been coupled with microwave technology wherein a microwave emitter bombards the filter with microwaves in order to burn off accumulated carbon. In general soot particles contain unburned hydrocarbons from various sources including unburned fuel and oil. Furthermore, a significant amount of unburned or partially burned diesel fuel moves through the exhaust system, when the engine is started from cold, and some of this becomes trapped in the filtration unit. Application of microwave energy is insufficient to completely combust this fuel, because there is insufficient oxygen in the filtration unit to support complete combustion. The result is the vaporization and emission of diesel fuel and diesel fuel fractions into the atmosphere.

Catalytic materials, including combinations of high surface area bulk ceria combined with additional metal oxides, have been disclosed for use in oxidation of oxidizable components of gas-borne streams, including diesel engine exhaust streams, in Vogel, U.S. Pat. No. 6,153,160, the entire contents of which is incorporated herein by reference. These materials suffer from degradation of ceria unless impregnated with zirconia which will require separate and costly impregnation step. Among other oxides, the zirconia crystals obtained by Vogel as the result of his impregnation step are also rather large (on the order of around 10-20 microns), which provides less available surface area for reaction. Furthermore, Vogel's patent describes ceria, a combination of ceria with titania, zirconia, ceria-zirconia, alumina, etc. There is no intent to specifically make ceria-zirconia. In any event, mixing zirconia with various metal oxides does not lead to a ceria-zirconia type stable [Spell out the acronym the first time it's used] or “OSC” catalyst but requires additional processing. It is quite well-known that ceria is subject to deterioration over extended use in automotive exhaust reduction catalysis systems whereas ceria-zirconia as indicated herein is significantly more stable over time under operating conditions of exhaust reduction catalysts.

Furthermore, using slurry-calcinable methods of application of catalytic/oxygen donor materials cannot work on filtration units where the dimensions of the porous substrates is small; slurry-calcinable methods can clog or plug porous structures where the holes are, say, 200 microns or less.

Accordingly, there remains a need in the art for apparatus and methods to prevent or limit such emissions, particularly during start up of the diesel engines, and in particular, there remains a need for oxygenating or catalytic materials that can help to oxidize these trapped diesel oil fractions, catalyze the removal of trapped carbon particles from the filter, or both. There also remains a need to deposit such catalyst materials by low cost, simple methods on a variety of substrates with unique properties for desired specific applications.

### SUMMARY OF THE INVENTION

The invention described herein specifically demonstrates fabrication of films of less than about 0.5 microns on the porous substrate with pores as small as 5-6 microns or even less to enable fabrication of diesel particulate filters using ceramic papers coated with oxygen storage material. Such devices will function at lower temperature than the conventional particulate filter, thereby, reducing the fuel penalty.

Other areas that could benefit from such catalytic systems and methods include piping for transportation of relatively high temperature hydrocarbon gases, such as natural gas or gaseous hydrocarbons used in ethylene cracking. Carbonization can occur on the inner surfaces of pipe or conduit used to transport hydrocarbon gases at high temperature. These carbon deposits can change the flow characteristics of the gases flowing through the pipe or conduit. There remains a need in the art to make these surfaces essentially self-cleaning in order to avoid or minimize build up of carbon, and the coating and coated materials of this invention satisfies that need.

In one aspect, the invention relates to catalytic coatings (and articles coated therewith) containing at least one rare earth metal oxide, and at least one transition metal oxide. The coatings are formed by a method for forming an oxidizing coating on a substrate, comprising:

(a) applying a liquid metal carboxylate composition, to the substrate, wherein the liquid metal carboxylate composition comprises a solution of at least one rare earth metal salt of a carboxylic acid and at least one transition metal salt of a carboxylic acid, in a solvent, and

(b) exposing the substrate with the applied liquid carboxylate to an environment that will convert at least some of the metal carboxylates to metal oxides, thereby forming an oxidizing coating on the substrate.

More particularly, the invention relates to catalytic coatings (and articles coated therewith) containing two or more rare earth metal oxides and at least one transition metal oxide. Even more particularly, the invention relates to catalytic coatings (and articles coated therewith), containing ceria, a second rare earth metal oxide, and a transition metal oxide. Even more particularly, the invention relates to catalytic coatings (and articles coated therewith) containing ceria, zirconia, and a second rare earth metal oxide. In particular cases, the second rare earth metal oxide can include praseodymium oxide.

Another embodiment of the invention relates to processes for applying the catalytic coatings described herein to porous surfaces, and to the preparation of filter papers, conduits, and other articles having the desirable properties imparted by the catalytic coating of the invention, and previously thought not able to be coated with coatings of the type described herein (such as steel conduit, more particularly, stainless steel conduit).

As explained herein, the coating of the invention provides increased durability, in part, because it penetrates the surface of the coated metal or ceramic to a depth, usually around 200 to 600 Angstroms, providing a firm anchor to the material being coated without the need for intermediate bonding layers. This allows a much thinner coating, typically around 0.1 to 1 μm in thickness—i.e., about 0.5 microns when approximately 6 layers are used, to be applied and provide equivalent protection to that provided by existing coating technologies. This, in turn, allows for cost savings in terms of the amount of coating material applied and retooling allowing for coating thickness in any important tolerances. In addition, the effect of any mismatches in physical, chemical, or crystallographic properties (e.g., in thermal expansion coefficients) is minimized by the use of much thinner coating material. The process of the invention permits the use of coatings of a wide variety of materials, including application of CeO_{y} and ZrO₂ coatings to ceramics and/or solid metals which were previously not thought capable of being coated with these materials, such as steel, more particularly, stainless steel. At the very least, the coating of such substrates was thought to require the use of exotic processes that involve expensive, and often commercially infeasible contact bonding agents, are required before ZrO₂ or CeO₂ can be applied). The present invention is a relatively low temperature process that does not damage or deform the steel, does not produce toxic or corrosive waste materials, and can be done on site, or “in the field” without the procurement of expensive capital equipment. The clear environmental and energy conservation benefits, and the avoidance of high temperature heat treatments and harsh chemical environments are beneficial in maintaining the desired strength or other properties of the metal parts being treated.

While not wishing to be bound by any theory, it has been found that the coating applied to the metal and/or ceramic parts following the procedures described and exemplified herein comprises a form of cubic zirconia that is stable at low temperatures, and is very fine grained (typically around 3 nm grain size, as determined by synchrotron XRD analysis). Similarly, X-Ray diffraction analysis at the High Temperature Materials Laboratory (HTML) at Oak Ridge National Laboratories (ORNL) showed that the cerium applied to metal parts according to the invention is fine grained as well (typically about 9 nm grain size). In the present invention, zirconia can be used a dopant for CeO₂ to improve the oxygen donor properties of CeO₂. At the atomic level, it is believed that the interaction of zirconia with ceria stabilizes its oxygen defect structure.

In summary, the inventors have discovered that the disclosed process for applying metal oxide coatings allows ceria-incorporated catalyst materials to be easily deposited on a variety of surfaces, including ceramic papers and metals. Previous work with metal oxide coatings has been limited to smooth surfaces such as steel (including stainless steel), carbide or metal oxides and did not suggest that such coatings could be successful on ceramic papers which, through the use of porous structural surfaces, allow an invention to deploy catalytic/oxygen donor materials with a significant BET. The invention clearly shows the advantages of using these new coated substrates in diesel particulate treatment and carbonization prevention. Specifically, our invention addresses:
1. A method to coat ceramic paper with meal oxides such as ceria and/or zirconia and/or praseodymium oxides, etc;
2. A method for coating metal parts that are susceptible to carbon fouling—e.g., ethylene cracking tubes to diminish coking and reduce the need for repeated cleaning of hydrocarbon transport pipes, or internal combustion engine parts such as egr valves, cylinders, heads, exhaust apparatus, etc;
3. A method for coating substrates with coatings according to the invention as precursor bonding agents for slurry coating of additional layers of the same or different materials;
4. A method coating substrates to produce zirconia-ceria powder that can be mixed with an appropriate metal oxide sol to make a more stable zirconia-ceria coating.

The diesel particulate prototypes fabricated using our methods show a superior soot oxidation in the 150-300° C. temperature range when microwave heating is used to supplement the heating of particulate filter by exhaust gases. This was evidenced by testing of carbon fouled ceramic papers untreated and treated with catalysts using our process, in testing that was conducted by Industrial Ceramics Solutions, Inc., Oak Ridge, Tenn., in 2004. This is just one of the many applications available to this invention.

Thus, our invention relates to a metal oxide or metallic coating that can be applied to substrate surfaces as a metal carboxylate solution, heat treated, and cooled to form a thin layer that penetrates a distance beneath the surface. The coating is hard, strongly adhered to the surface, and active in the sense that it either contains a metal oxide that provides oxygen necessary to support combustion (and regenerates later when oxygen is plentiful), or in the sense that the presence of metallic species in the coating reduce the combustion temperature of carbon or hydrocarbon species whose decomposition is desired.

In a particular embodiment, the invention provides a coating of material capable of providing oxygen to a combustion process, in particular, a combustion process that involves microwave heating. In the method of the invention, the surface of a substrate is coated with a composition of liquid metal carboxylate followed by heat treatment in non-oxidizing atmosphere at a minimum temperature of 420° C. for about 3-5 minutes thereby forming an oxide layer on the surface of the substrate. This oxide layer can desirably contain a rare earth oxide and/or a transition metal oxide.

In this regard, the invention includes a filter trap comprising:

(a) a substrate comprising metal or ceramic particles or fibers, and

(b) an adherent coating comprising at least one rare earth metal oxide and at least one transition metal oxide;

wherein the coating penetrates a distance beneath the surface of the particles or fibers.

In another particular embodiment, the invention provides a coating that decreases the combustion temperature and/or increases combustion efficiency by providing a combustion catalyst in combination with a rare earth metal oxide (e.g., ceria, praseodymium oxide, neodymium oxide, lanthanum oxide, and combinations thereof), a transition metal (e.g., zirconium oxide, niobium oxide, molybdenum oxide, technetium oxide, ruthenium oxide, and combinations thereof), or combinations thereof. This combustion catalyst can desirably contain metallic platinum, palladium, rhodium, ruthenium, iridium, and other catalytic metals. When a catalyst such as platinum is used, the oxide layer is formed as set forth above and then the platinum oxide is reduced to platinum by heating the film in a hydrogen atmosphere at 350° C. This temperature allows reduction of the platinum oxide to pure platinum, without reducing the ceria/zirconia oxygen donor component of the film.

In this regard, the invention includes a fouling-resistant conduit for transport of hydrocarbons, comprising:

an outer structural conduit material having an inner surface adapted to contact and convey hydrocarbons; and

an inner adherent coating disposed on the inner surface, comprising:
at least one rare earth metal oxide and at least one transition metal oxide;
   wherein the adherent coating penetrates a distance beneath the inner surface of the outer structural conduit material. The conduit substrate is may be steel, more particularly stainless steel.

In yet another embodiment, the invention relates to a contact bonding agent for calcinations/slurry treatments which are used on flat surfaces in order to increase BET surface area of the resulting catalytic material (See, VOGEL). For instance, alumina, silica, ceria, or ceria-zirconia sol can be used as bonding agents for ceria-zirconia powders prepared through use of the present invention. In this protocol, high surface powders can be coated on the substrate without high temperature treatment requirement that is generally detrimental to surfaces. For example, ceria-zirconia powder prepared by the method of this invention at low temperature can be suspended in alumina sol and coated. Alumina sol converts to gel trapping the powder in the gel structure. Upon drying and low-temperature thermal treatment, a stable coating on the desired substrate is obtained. Conversely, large alumina, silica, ceria or other powders can be mixed with our Ce and/or Zr carboxylates, and/or catalytic materials, coating the particulate powders with an oxide and/or catalytic film. The advantages of the present invention's fine grain size then can be magnified by the BET advantage of using a sol gel slurry method in combination with our invention.

In this regard, the invention includes a method for forming an oxidizing coating on a fouling resistant substrate, comprising:

(a) applying a liquid metal carboxylate composition to the substrate, wherein the liquid metal carboxylate composition comprises a solution of at least one rare earth metal salt of a carboxylic acid and at least one transition metal salt of a carboxylic acid, in a solvent, and

(b) exposing the liquid carboxylate to a low temperature heating environment that will convert at least some of the metal carboxylates to solid state metal oxides, and

(c) grinding the metal oxides into a fine granular powder with a particle size of about 0.1-30 microns; and

(d) drying the resulting ground powder and subjecting it to a low-temperature thermal treatment, thereby obtaining a stable coating on the desired substrate.

In yet another embodiment, the invention relates to a thermal shock resistant coating having layers of a transition metal carbide/transition metal oxide, and a layer of transition metal. In this embodiment, the top layer of metal is partially oxidized before coating with CeO₂-nZrO₂ to improve adhesion to metal that does not directly bond with CeO₂-nZrO₂. Thus, an interface of metal oxide forms that on one side is bonded to metal and other to CeO₂-nZrO₂.

In a particular embodiment, the invention relates to a method for forming an oxidizing coating on a fouling resistant substrate, comprising:

(a) applying a liquid metal carboxylate composition, or a solution thereof, to the substrate, wherein the liquid metal carboxylate composition comprises a solution of at least one rare earth metal salt of a carboxylic acid and at least one transition metal salt of a carboxylic acid, in a solvent, and

(b) introducing into the liquid carboxylate in a low temperature heating environment a metal oxide powder having a particle size from about 1-100 microns, and

(c) applying the resulting mixture to a ceramic or metal substrate at 420-480° C.;

whereby the oxide powders suspended in the liquid carboxylic acid become trapped in the resulting structure of the metal oxide coating when the metal oxide coating attaches to the substrate; and

(d) reducing the catalytic materials in an atmosphere of Argon and Hydrogen at 350° C. The metal oxides that can be bonded by this method include alumina, ceria, zirconia, titanium oxides, nickel oxide, chromium oxide, iron oxides, and combinations thereof.

In another embodiment, the invention relates to a fouling-resistant conduit for transport of hydrocarbons, comprising:

an outer structural conduit material having an inner surface adapted to contact and convey hydrocarbons; and

an inner adherent coating disposed on the inner surface, comprising:
at least one rare earth metal oxide and at least one transition metal oxide;
   wherein the adherent coating penetrates a distance beneath the inner surface of the outer structural conduit material; and
   wherein the adherent coating is covered by a slurry calcification to impart catalytic properties to the surface; and

the inner adherent coating acts as a bonding agent for the slurry calcification coating.

Among other advantages, the materials and methods of the invention result in a high surface area catalytic material that:
Increases the volume of trapped diesel oils burned by providing an oxidizing agent for combustion;
Provides more efficient combustion at both lower and higher temperatures than can be obtained without the use of the invention; and
Reduces carbon build-up in internal combustion engines, and conduits for transporting hydrocarbons, such as, and in particular in tubes or pipes for transporting natural gas.

### DETAILED DESCRIPTION OF SPECIFIC EMBODIMENTS

As used herein, the term “rare earth metal” includes those metals in the lanthanide series of the Periodic Table, including lanthanum. The term “transition metal” includes metals in Groups 3-12 of the Periodic Table (but excludes rare earth metals). The term “metal oxide” particularly as used in conjunction with the above terms includes any oxide that can form or be prepared from the metal, irrespective of whether it is naturally occurring or not.

As described above, the invention provides a hard, adherent coating of oxide materials and/or catalytic materials that drive or enhance oxidation or combustion of hydrocarbons and other combustible species.

The general method of preparation is to form a solution of carboxylate salts of the desired metals, in this case, carboxylate salts of rare earth metals, transition metals, and/or any noble metal salts, such as platinum, palladium, rhodium, ruthenium, etc. in varying combinations which may be soluble in carboxylic acid solution. The carboxylate solution is then applied to the substrate to be coated, such as a metal or ceramic filter paper, the inner surface of a conduit, etc., and subjected to a heat treatment to form the desired oxides and/or metallic catalyst. The oxide coating penetrates a distance beneath the surface of the substrate, providing excellent adherence and long life. In addition, the preparation methods are simple, can be carried out without specialized equipment, and do not involve costly and difficult impregnation.

Consequently, the invention includes methods for forming an oxidizing coating on a substrate, by:

(a) applying a liquid metal carboxylate composition, or a solution thereof, to the substrate, wherein the liquid metal carboxylate composition comprises a solution of at least one rare earth metal salt of a carboxylic acid and at least one transition metal salt of a carboxylic acid, in a solvent, and

(b) exposing the substrate with the applied liquid carboxylate to an environment that will convert at least some of the metal carboxylates to metal oxides.

Representative coating compositions that have been found to be particularly suitable as catalytic coatings include, but are not limited to:
i. CeO₂—ZrO₂ where CeO₂ is about 10-90 wt %;
ii. CeO₂—PrO₂ where PrO₂ is 0 to about 50 wt %;
iii. PrO₂—CeO₂—ZrO₂ where PrO₂—CeO₂ is 10-90%
iv. PrO₂—ZrO₂ where PrO₂ is 10-90%
v. In each of i-iv above, in which Pt, Pd and/or other catalytic metals (such as Ru, Rh, Ir, Ni, or mixtures thereof)are added singly or in combination in an aggregate volume equal to 0.5-8% of the total volume of the oxygen donor compounds above. These metals are reduced to pure metal form during the method of the invention without changing the oxide state of ceria, zirconia, or praseodymium oxide.

Further examples include coatings having about 10-90 wt % ceria, about 0 to about 50 wt % praseodymium oxide, and about 10 to about 50 wt % zirconia. These compositions can contain based on the total weight of coating:

about 0.5 to about 3 wt % Pt; or

about 0.5 to about 3 wt % Pd; or

about 0.5 to about 3 wt % Rh; or

about 0.5 to about 3 wt % Ru; or

about 0.5 to about 3 wt % Ir; or

about 0.5 to about 3 wt % of metallic platinum and palladium combined.

When zirconia is used, the method of the invention produces coatings having zirconia crystal grains having an average diameter of about 3-9 nm. When ceria is used, the method of the invention produces grains some of which have a diameter of 9-18 nm.

In one embodiment, liquid metal carboxylate solution comprises a total concentration of metals of between about 30 and about 160 g/L. More particularly, the amount of metallic Pt, Pd, or both, can be less than about 5 wt %, based upon the total weight of the liquid metal carboxylate composition. The amount of metallic Rh, Ru, or both, can also be less than about 5 wt %, based upon the total weight of the liquid metal carboxylate composition. Even more particularly, the amount of metallic Pt, Pd, Rh, Ru, Ni, Ir individually or in any combination, are less than about 5 wt %, based upon the total weight of the liquid metal carboxylate composition.

In particular embodiments, the amount of metallic Pt, Pd, or both, can be between about 0.5 wt % and about 3 wt %, based upon the total weight of the liquid metal carboxylate composition. The amount of metallic Rh, Ru, or both, can also be between about 0.5 wt % and about 3 wt %, based upon the total weight of the liquid metal carboxylate composition. Even more particularly, the amount of metallic Pt, Pd, Rh, Ru, Ni, Ir individually or in any combination, can be between about 0.5 wt % and about 3 wt %, based upon the total weight of the liquid metal carboxylate composition.

The method of the invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLES

(A) The following examples illustrate the application of the present process to the ceramic papers and/or filters:

NOTE: The preparation of the coatings described herein was done at C-3 Intl, LLC application lab in Alpharetta, Ga. The ceramic papers used in diesel particulate traps were manufactured by Industrial Ceramic Solutions, Inc. located in Oak Ridge, Tenn., and were coated with the coating described in Example A-1 below. Since the liquid applied to the papers require less viscosity for maximum coverage through its fibers, the solution prepared in Example A-1 was diluted by the addition of the n-Octane mentioned in the Examples below. The liquid was then applied by dipping the papers in the coating liquid at room temperature, or by dipping or painting the liquid on, and then heating the coated substrate to 420 degrees C. in air, or greater, and holding the temperature for one minute or more. Cooling the treated paper or filter to room temperature allows a thin metal oxide film to solidify. Then the coated paper or filter is reheated in an Argon and Hydrogen atmosphere (93% Argon, 7% Hydrogen) at 350 degrees C. for thirty minutes or more; this allows the catalyst material—e.g., Pt, Pd, Rh, Ru, Ir, or Ni—to reduce to pure metal form while allowing the oxygen donor material—ceria, zirconia, or Praseodymium oxide—to remain as an oxide (oxygen donor).

As indicated above, materials that can be desirably coated with the composition of the invention according to the method include metallic or ceramic filter papers. Consequently, the invention includes filter traps having:

(a) a substrate comprising metal or ceramic particles or fibers, and

(b) an adherent coating comprising at least one rare earth metal oxide and at least one transition metal oxide wherein the coating penetrates a distance beneath the surface of the particles or fibers.

The materials prepared under Example (A) 1-3 below are applied to the ceramic paper or filter by spraying,

### Example A-1

### Preparation of the Cerium Carboxylate Solution with a Platinum Catalyst and a Dilutant of n-Octane

Unless otherwise stated, all components utilized in these examples for preparation of the metal carboxylate were obtained from the Johnson Matthey Co. (1999-2000) catalog as Alfa Aesar A. The components are the salts of acid and metal. It is necessary to dilute them with the pure acid in order to use them in the process. Specifically, 90 grams of 2-ethylhexanoic acid (Stock No. 15419), and 5.0 grams of Pt(O)-divinyl 1, 1, 3, 3-tetra methyldisiloxane (Stock No. 41508) were put into a mixer at room temperature and stirred for four or five minutes Then, 134 grams of Ce (III) 2-ethylhexanoate, 49% in 2-ethlhexanoic acid (Stock No. 40451) was stirred in at room temperature for five minutes. Finally, depending on the need for dilution/viscosity, add either: (a) 90 grams of n-Octane (Avacado Research Chemicals, Ltd, Stock No. A-13181); or (b) 180 grams of the same; or (c) 270 grams of the same.

### Example A-2

### Preparation of the Cerium and Zirconium Carboxylate Solution with Platinum as a Catalyst and a higher ratio of Dilutant of n-Octane

Unless otherwise stated, all components utilized in these examples for preparation of the metal carboxylate were obtained from the Johnson Matthey Co. (1999-2000) catalog as Alfa Aesar A. The components are the salts of acid and metal. It is necessary to dilute them with the pure acid in order to use them in the process. Specifically, 10 grams of 2-ethylhexanoic acid (Stock No. 15419), and 5.0 grams of Pt(O)-divinyl 1, 1, 3, 3-tetra methyldisiloxane (Stock No. 41508) were put into a mixer at room temperature and stirred for four or five minutes. Then, 66 grams of Ce (III) 2-ethylhexanoate, 49% in 2-ethlhexanoic acid (Stock No. 40451) was stirred in at room temperature for five minutes. Then Zr (IV) 2 ethylhexanoate (Stock No. 39174—96%+purity). Finally, depending on the need for dilution/viscosity, add either: (a) 1410 grams of n-Octane (Avacado Research Chemicals, Ltd, Stock No. A-13181); or (b) 2205 grams of the same.

### Example A-3

### Preparation of the Cerium Carboxylate Solution with Zirconia, and Rhodium as a Catalyst and a Dilutant of n-Octane

Unless otherwise stated, all components utilized in these examples for preparation of the metal carboxylate were obtained from the Johnson Matthey Co. (1999-2000) catalog as Alfa Aesar A. The components are the salts of acid and metal. It is necessary to dilute them with the pure acid in order to use them in the process. Specifically, 90 grams of 2-ethylhexanoic acid (Stock No. 15419), and 1.0 grams of Rhodium octonate dimer (Stock No. 39825) were put into a mixer at room temperature and stirred for four or five minutes Then, 210 grams of Ce (III) 2-ethylhexanoate, 49% in 2-ethlhexanoic acid (Stock No. 40451) was stirred in at room temperature for five minutes. Finally, depending on the need for dilution/viscosity, add either: (a) 90 grams of n-Octane (Avacado Research Chemicals, Ltd, Stock No. A-13181); or (b) 180 grams of the same; or (c) 270 grams of same.

The other catalysts referenced herein, such as Ruthenium, Palladium, Nickel, Iridium etc., may be used in combination with Platinum or Rhodium, and with oxygen donor materials including ceria and/or zirconia and/or praseodymium and in addition may be used in substitution for catalysts referenced in the examples above when their particular properties are desirable—e.g., Platinum catalysis is superior at lower temperatures, but Palladium may be preferable at higher temperature regimes.

(B) The following examples illustrate the application of the present process to coating steel pipes and other metal parts, such as those used in an internal combustion engine.

### Example B-1

### Metal Parts, such as Ethylene Cracking Tubes, Hydrocarbon Transport Pipes, and Engine Parts that are Prone to Carbon Fouling

These parts may be covered with protective lubricants, dirt, or other materials either from use or the process used to manufacture them and therefore may require cleansing. This can be accomplished using a suitable cleansing solvent or other fluid (e.g., placing the parts in boiling carbon tetrachloride solvent for approximately 10 to 15 minutes.) The materials prepared under Example (A) 1-3, for example, may then be applied by spraying, dipping or painting the liquid on and then heating the metal substrate to 420 degrees C., or greater, and holding the temperature there for no less than one minute. Cooling the treated substrate to room temperature allows a thin metal oxide film to solidify. Then the coated substrate is reheated in an Argon and Hydrogen atmosphere (93% Argon, 7% Hydrogen) at 350 degrees C. for thirty minutes or more to allow the catalytic materials to reduce to a metal form.

Dilutants such as n-Octane used in Examples (A) 1-3 are not generally needed, used or are desirable in coating these types of metal parts, so they should be excluded from the preparation of liquids to be applied to these parts.

This invention also includes fouling-resistant conduits for transport of hydrocarbons, or moving or stationary internal combustion engine parts having a propensity to carbon foul, having:
(a) an outer structural conduit material having an inner surface adapted to contact and convey hydrocarbons; and
(b) an inner adherent coating disposed on the inner surface, comprising of:
   (i) at least one rare earth metal oxide and at least one transition metal oxide;
   (ii) wherein the adherent coating penetrates a distance beneath the inner surface of the outer structural conduit material.

The invention also includes creating a more stable zirconia-ceria powder having:
(a) the same stability properties as contained in the original zirconia-ceria coatings, wherein
(b) the coating is ground into a powder that can be introduced as a stable zirconia-ceria powder in sol gel methods of coatings.

The invention also includes laying down an oxide coating to be used as a precursor bonding agent for methods deploying catalysts through extant calcinations-slurry methods, providing:
(a) a better bond to the substrate, and
(b) more oxygen donor materials to promote catalytic action.

In all four applications, the use of ceria and praseodymium oxide as the rare earth metal oxides has been found to be desirable, as has the use of zirconia as the transition metal oxide. By using the method of the invention, it is unexpectedly possible to obtain zirconia crystallites having a mean diameter of around 3-9 nm, providing excellent and improved surface area for reaction with hydrocarbons.

(C) Testing the Present Invention:

### Example C-1

### TGA Testing

A preliminary TGA testing was conducted at Oak Ridge National Laboratory's HTML Section. The invention's method was used to prepare ceria in granular form. The ceria was then mixed with finely ground carbon particulates which had been removed from Industrial Ceramic Solutions, Inc. (ICS) traps (ceramic papers fouled with carbon). When combined in a crucible of approximately 80% hydrocarbon and 20% ceria, the sample was weighed in and inserted into a TGA furnace. The results indicated oxygen donor activity which appeared to reduce the combustion temperature of the hydrocarbon substantially enough (50-70 degrees C.) to justify bench testing at ICS.

### Example C-2

### Testing on Ceramic Filters at ICS

The test at ICS involved coating three ceramic papers with ceria doped with platinum, as shown under Example 3 above. These papers, along with three untreated papers, were carbon fouled in an ICS trap. (See “After 300 Deg C. Firing” picture in FIG. 1 above.) They were then heated to 300 C. The treated papers appeared to burn off most of the carbon, whereas the untreated papers appeared to burn off very little. In addition, the weight changes in the papers inferred that some of the carbon on the treated papers was actually burned off during the application of carbon in the traps, at a much lower temperature range of 120-240° C.

What is claimed is:

1. A method for forming an oxidizing coating on a substrate, comprising:
(a) applying a liquid metal carboxylate composition, to the substrate, wherein the liquid metal carboxylate composition comprises a solution of at least one rare earth metal salt of a carboxylic acid and at least one transition metal salt of a carboxylic acid, in a solvent, and
(b) exposing the substrate with the applied liquid carboxylate to an environment that will convert at least some of the metal carboxylates to metal oxides, thereby forming an oxidizing coating on the substrate.

2. The method of claim 1, wherein the liquid metal carboxylate composition comprises a cerium carboxylate and the metal oxides comprise ceria.

3. The method of claim 2, wherein the liquid metal carboxylate composition further comprises a zirconium carboxylate and the metal oxides further comprise zirconia.

4. The method of claim 3, wherein the zirconia comprises crystal grains having an average diameter of about 3-9 nm.

5. The method of claim 3, wherein the ceria comprises crystal grains, some of which have a diameter of 9-18 nm.

6. The method of claim 1, wherein the liquid metal carboxylate composition further comprises carboxylates of praseodymium, and the metal oxides further comprise praseodymium oxide.

7. The method of claim 6, wherein the liquid metal carboxylate composition further comprises carboxylates of Pt, Pd, or mixtures thereof, and wherein these form metal oxide coatings in which Pt, Pd, or mixtures thereof are reduced to a pure metal form without changing the oxide state of the ceria or zirconia or praseodymium oxide.

8. The method of claim 6, wherein the liquid metal carboxylate composition further comprises carboxylates of Ru, Rh, Ir, Ni or mixtures thereof, and wherein these form metal oxide coatings in which the Ru, Rh, Ir, Ni or mixtures thereof are reduced to pure metal form without changing the oxide state of the ceria or zirconia or praseodymium oxide.

9. The method of claim 1, wherein the liquid metal carboxylate composition comprises carboxylates of Ce, Zr, Pr or mixtures thereof, and wherein the coating further comprises metallic Pt, Pd, Ir, Ni, Ru, Rh or mixtures thereof.

10. The method of claim 1, wherein the liquid metal carboxylate solution comprises a total concentration of metals of between about 30 and about 160 g/L.

11. The method of claim 7, wherein the amount of metallic Pt, Pd, or both, is less than about 5 wt %, based upon the total weight of the liquid metal carboxylate composition.

12. The method of claim 8, wherein the amount of metallic Rh, Ru, or both, is less than about 5 wt %, based upon the total weight of the liquid metal carboxylate composition.

13. The method of claim 9, wherein the amount of metallic Pt, Pd, Rh, Ru, Ni, Ir individually or in any combination, are less than about 5 wt %, based upon the total weight of the liquid metal carboxylate composition.

14. The method of claim 11, wherein the amount of metallic Pt, Pd, or both, is between about 0.5 wt % and about 3 wt %.

15. The method of claim 12, wherein the amount of metallic Rh, Ru, or both, is between about 0.5 wt % and about 3 wt %.

16. The method of claim 14, wherein the amount of metallic Pt, Pd, Rh, Ru, Ni, Ir individually or in any combination, is between about 0.5 wt % and about 3 wt %.

17. A filter trap comprising:
(a) a substrate comprising metal or ceramic particles or fibers, and
(b) an adherent coating comprising at least one rare earth metal oxide and at least one transition metal oxide;
wherein the coating penetrates a distance beneath the surface of the particles or fibers.

18. The filter trap of claim 17, wherein the rare earth metal oxide is selected from the group consisting of ceria, praseodymium oxide, neodymium oxide, lanthanum oxide, and combinations thereof.

19. The filter trap of claim 17, wherein the transition metal oxide comprises one or more of zirconium oxide, niobium oxide, molybdenum oxide, technetium oxide, ruthenium oxide, and combinations thereof.

20. The filter trap of claim 17, wherein the adherent coating further comprises metallic platinum, metallic palladium, or a combination thereof.

21. The filter trap of claim 17, wherein the rare earth metal oxide comprises ceria, praseodymium oxide, or a combination thereof.

22. The filter trap of claim 17, wherein the transition metal oxide comprises zirconia having a crystallite size ranging from about 3-9 nm.

23. The filter trap of claim 17, wherein the transition metal oxide comprises ceria having a crystallite size ranging from about 9-18 nm.

24. The filter trap of claim 17, wherein the adherent coating comprises, based on the total weight of coating:
about 10 to about 90 wt % ceria;
about 0 to about 50 wt % praseodymium oxide; and
about 10 to about 50 wt % zirconia.

25. The filter trap of claim 24, wherein the adherent coating comprises, based on the total weight of coating:
about 0.5 to about 3 wt % Pt; or
about 0.5 to about 3 wt % Pd; or
about 0.5 to about 3 wt % Rh; or
about 0.5 to about 3 wt % Ru; or
about 0.5 to about 3 wt % Ir; or
about 0.5 to about 3 wt % of metallic platinum and palladium combined.

26. A fouling-resistant conduit for transport of hydrocarbons, comprising: an outer structural conduit material having an inner surface adapted to contact and convey hydrocarbons; and
an inner adherent coating disposed on the inner surface, comprising:
at least one rare earth metal oxide and at least one transition metal oxide;
wherein the adherent coating penetrates a distance beneath the inner surface of the outer structural conduit material.

27. The fouling-resistant conduit of claim 26, wherein the outer structural conduit material is steel.

28. The fouling-resistant conduit of claim 26, wherein the rare earth metal oxide comprises ceria.

29. The fouling-resistant conduit of claim 26, wherein the rare earth metal oxide further comprises praseodymium oxide.

30. The fouling-resistant conduit of claim 26, wherein the transition metal oxide comprises zirconia.

31. The fouling-resistant conduit of claim 30, wherein the zirconia has an average crystallite size of around 3-9 nm.

32. The fouling-resistant conduit of claim 26, wherein the inner adherent coating further comprises metallic Platinum, metallic Palladium, or both.

33. The fouling-resistant conduit of claim 26, wherein the inner adherent coating further comprises metallic Rhodium, metallic Ruthenium, or both.

34. The fouling-resistant conduit of claim 26, wherein the inner adherent coating further comprises metallic Platinum, Nickel, metallic Iridium or any combination of the three.

35. A method for forming an oxidizing coating on a fouling resistant substrate, comprising:
(a) applying a liquid metal carboxylate composition to the substrate, wherein the liquid metal carboxylate composition comprises a solution of at least one rare earth metal salt of a carboxylic acid and at least one transition metal salt of a carboxylic acid, in a solvent, and
(b) exposing the liquid carboxylate to a low temperature heating environment that will convert at least some of the metal carboxylates to solid state metal oxides, and
(c) grinding the metal oxides into a fine granular powder with a particle size of about 0.1-30 microns; and
(d) drying the resulting ground powder and subjecting it to a low-temperature thermal treatment, thereby obtaining a stable coating on the desired substrate.

36. The method of claim 35, further comprising:
(e) suspending the ceria-zirconia powder in an alumina sol, whereby the alumina sol converts to a gel, trapping the powder in the gel structure.

37. The method of claim 35, wherein the outer structural conduit material is stainless steel.

38. The method of claim 35, wherein the rare earth metal oxide comprises ceria.

39. The method of claim 35, wherein the rare earth metal oxide further comprises praseodymium oxide.

40. The method of claim 35, wherein the transition metal oxide comprises zirconia.

41. The method of claim 40, wherein the zirconia has an average crystallite size of around 3-9 nm.

42. The method of claim 35, wherein the inner adherent coating further comprises metallic Platinum, metallic Palladium, or both.

43. The method of claim 35, wherein the inner adherent coating further comprises metallic Platinum, metallic Iridium, Nickel, or any combination of the three.

44. A method for forming an oxidizing coating on a fouling resistant substrate, comprising:
(a) applying a liquid metal carboxylate composition, or a solution thereof, to the substrate, wherein the liquid metal carboxylate composition comprises a solution of at least one rare earth metal salt of a carboxylic acid and at least one transition metal salt of a carboxylic acid, in a solvent, and
(b) introducing into the liquid carboxylate in a low temperature heating environment a metal oxide powder having a particle size from about 1-100 microns, and
(c) applying the resulting mixture to a ceramic or metal substrate at 420-480° C.;
whereby the oxide powders suspended in the liquid carboxylic acid become trapped in the resulting structure of the metal oxide coating when the metal oxide coating attaches to the substrate; and
(d) reducing the catalytic materials in an atmosphere of Argon and Hydrogen at 350° C.

45. The method of claim 44, wherein the outer structural conduit material is steel.

46. The method of claim 44, wherein the rare earth metal oxide comprises ceria.

47. The method of claim 44, wherein the rare earth metal oxide further comprises praseodymium oxide.

48. The method of claim 44, wherein the transition metal oxide comprises zirconia.

49. The method of claim 48, wherein the zirconia has an average crystallite size of around 3-9 nm.

50. The method of claim 44, wherein the inner adherent coating further comprises metallic Platinum, metallic Palladium, or both.

51. The method of claim 44, wherein the inner adherent coating further comprises metallic Platinum, metallic Iridium, metallic Nickel, or any combination of the three.

52. The method of claim 44, wherein the metal oxide particulate powder comprises alumina.

53. The method of claim 44, wherein the metal oxide particulate powder comprises ceria.

54. The method of claim 44, wherein the metal oxide particulate powder comprises zirconia.

55. The method of claim 44, wherein the metal oxide particulate powder comprises titanium oxide.

56. The method of claim 44, wherein the metal oxide particulate powder comprises nickel oxide.

57. The method of claim 44, wherein the metal oxide particulate powder comprises chromium oxide.

58. The method of claim 44, wherein the metal oxide particulate powder comprises iron oxide.

59. A fouling-resistant conduit for transport of hydrocarbons, comprising:
an outer structural conduit material having an inner surface adapted to contact and convey hydrocarbons; and
an inner adherent coating disposed on the inner surface, comprising:
at least one rare earth metal oxide and at least one transition metal oxide;
wherein the adherent coating penetrates a distance beneath the inner surface of the outer structural conduit material; and
wherein the adherent coating is covered by a slurry calcification to impart catalytic properties to the surface; and
the inner adherent coating acts as a bonding agent for the slurry calcification coating.
